(19) United States
(12) Patent Application Publication
(10) Pub. No.: US 2021/0398003 A1
(43) Pub. Date: Dec. 23, 2021

(54) METHOD AND SYSTEM FOR FORECASTING A FAILURE OF A VENTILATOR GROUP, AND CORRESPONDING VENTILATOR GROUP

(71) Applicant: ZIEHL-ABEGG SE, Künzelsau (DE)

(72) Inventors: Bjoern WENGER, Schrozberg (DE); Michael AICHELE, Neuenstein (DE)

(21) Appl. No.: 17/292,708

(22) PCT Filed: Oct. 9, 2019
(86) PCT No.: PCT/DE2019/200117

§ 371 Date: May 10, 2021

(30) Foreign Application Priority Data
Nov. 8, 2018 (DE) 10 2018 219 094.1

(51) Int. Cl. G06N 7/00; G06Q 10/00

(52) U.S. Cl. CPC G06N 7/005; G06Q 10/20

(57) ABSTRACT

It is a method for predicting a failure of a fan group with N fans, of which n fans are redundant, wherein 1<n≤N. Upon failure of n fans, there is a failure of the fan group. The probabilities of failure of the fans as a function of an operating time of the fan group can be described by a probability distribution, wherein the probability distribution can be parameterized by at least one parameter. The method comprises the steps of:
generating a first probability of failure, which indicates a probability of a first failure of a fan of the fan group,
generating an n-th probability of failure, which indicates a probability of an n-th failure of a fan of the fan group,
determining a first time of failure, wherein the first time of failure indicates the operating time of the fan group until the first failure of a fan occurs,
generating a parameterized probability distribution by approximating the probability distribution to a first pair of values consisting of the first probability of failure and the first time of failure, and
calculating the n-th time of failure as the time of the n-th failure of a fan by means of the parameterized probability distribution and the n-th probability of failure.

A corresponding system and a fan group with such a system are also described.

This patent application is a 35 U.S.C. § 371 national state entry based on and claiming priority to International Patent Application PCT/DE219/200117, filed on Oct. 9, 2019, which in turn claims priority to German Patent Application DE 10 2018 219 094.1, filed on Nov. 8, 2018, the disclosures of which are incorporated herein by reference in their entireties.

The disclosure relates to a method and a system for predicting a failure of a fan group with N fans, of which n fans are redundant, wherein upon failure of n fans, there is a failure of the fan group, and wherein 1<n≤N. The disclosure also relates a corresponding fan group.

Instead of individual fans, in many instances fan groups are used particularly in the case of the ventilation or air conditioning of rooms or facilities. In this case, several fans deliver air at the same rate for an application, the fans being then usually arranged side by side. If the fan group has no redundancy, the failure of a fan of the fan group means that the fan group can no longer move enough air. This can—depending on the use of the fan group—have far-reaching consequences. For example, when the fan group is used in a heat exchanger of a cooling system, said fan group no longer can move enough air past the heat exchanger, so that the cooling system no longer can ensure sufficient cooling. If the fan group is used to ventilate a building or a hall, the failure of the fan group can result in insufficient ventilation or in a complete failure. Therefore, such fan groups are often designed to have redundant fans. This means that the fan group is dimensioned in such a way that the maximum possible air flow rate of the fan group is higher than would actually be necessary for the function of the fan group. In the case of n redundant fans, only once n−1 fans have failed, the fan group is approaching failure. Once the next fan has failed, the fan group no longer can move enough air, representing a failure of the fan group. This means that fan groups with such a redundant design do not need service and failed fans do not need to be replaced immediately after failure of a first fan, but only then when all or nearly all redundant fans have failed. In most cases, the entire fan group is replaced. In such scenarios it is of interest to be able to predict the time of the n-th failure of a fan, and thus the failure of the fan group.

The service life of a fan depends on many different factors. In addition to design factors, such as, for example, the design of the bearings or adequate compensation for imbalance, the conditions under which the fan is operated have a crucial influence on the service life. Humidity, temperature, vibration, dirt or ice accumulation have a crucial impact on the service life of the fan.

Fans are known from practice which have internal sensors and can estimate the remaining operating time from recorded measured values. The disadvantage of these fans is that a not inconsiderable effort has to be made to determine the remaining service life. In addition, it is usually irrelevant in a fan group how long the estimated remaining operating time of each individual fan is. It is important rather when a system failure of the fan group (i.e. failure of all redundant fans) is to be feared.

In the case of fans that do not have such internal sensors, actual coefficients of the service life calculation for various operating situations would have to be determined with complex measurement series. In addition, sensors must be mounted close to the fans, which sensors measure service life-influencing physical variables such as temperature or vibration, and enable a determination of coefficients of service life calculation. This approach also creates a significant extra effort. This extra effort is further increased if a large portfolio of different fans would have to be covered.

It is the object of the present disclosure to configure and further develop a method, a system and a fan group of the type mentioned above in such a way that a prediction of a failure of a fan group is possible using simple means.

According to the disclosure, the foregoing object is achieved by the features described and claimed herein. Accordingly, in the method in question, probabilities of failure of the fans as a function of an operating time of the fan group can be described by a probability distribution, wherein the probability distribution can be parameterized by at least one parameter. Hereby the method comprises the steps of:
generating a first probability of failure, which indicates a probability of a first failure of a fan of the fan group,
generating an n-th probability of failure, which indicates a probability of an n-th failure of a fan of the fan group,
determining a first time of failure, wherein the first time of failure indicates the operating time of the fan group until the first failure of a fan occurs,
generating a parameterized probability distribution by approximating the probability distribution to a first pair of values consisting of the first probability of failure and the first time of failure, and
calculating the n-th time of failure as the time of the n-th failure of a fan by means of the parameterized probability distribution and the n-th probability of failure.

With regard to a system, the above object is achieved by the features described and claimed herein. Accordingly, in the system in question, probabilities of failure of the fans as a function of an operating time of the fan group can be described by a probability distribution, wherein the probability distribution can be parameterized by at least one parameter. This system further comprises:
a monitoring unit formed for detecting failures of fans of the fan group,
a time measuring unit formed for determining a time of failure of a fan, wherein the time measuring unit is connected communicatively with the monitoring unit, and in each case measures the operating time of the fan group until a failure of a fan occurs,
a probability unit formed for generating probabilities of failure of fans of the fan group,
a parameterization unit formed for generating a parameterized probability distribution by approximating the probability distribution to at least one generated pair of values, wherein the at least one generated pair of values comprises a probability of failure and an associated measured time of failure, and
a failure calculation unit that is formed to calculate a predicted time of failure of the fan group based on the parameterized probability distribution and an n-th probability of failure.

With regard to the fan group, the above object is achieved by the features described and claimed herein. Accordingly, the fan group in question consists of N fans, of which n fans are redundant, as well as a system according to the disclosure for predicting a failure of the fan group.

In a manner according to the disclosure, it was first recognized that it is generally irrelevant for the prediction of a time of failure of a fan group when a specific fan of the fan group actually fails. It is much more important when all n redundant fans will have failed, so that sufficient air delivery by the fan group can no longer be assured.

It has been recognized further that the operating conditions relevant for the service life of a fan most in most cases are very similar across all fans of a fan group. For fans the service life is particularly determined by the service life of the bearing(s) with the rotor is mounted rotatably relative to the stator. An important point here is how long the lubricant (usually bearing grease) introduced into the bearing can reliably lubricate the bearing. On the one hand, the lubricating properties of the lubricant are reduced with increasing age. On the other hand, lubricant loss can occur with increasing operating time of the bearing, thereby wetting the rolling elements of the bearing with lubricant may no longer be sufficient. Important parameters for the service life of the lubricant are in this case the temperature at which the bearing is operated and the installation position of the fan (i.e. in which direction the axis of the rotor points when the fan is operated). Another aspect includes vibration stresses of the fan, which can affect the service life of the bearings in addition, depending on the extent. Buildup on the blades of the fan can also reduce the service life, as this buildup usually leads to increasing imbalance and thus increased vibration stress on the bearings. These parameters will not differ or only insignificantly across a fan group. For example, all fans in the fan group are usually installed in approximately the same installation position. The prevailing temperatures will also not differ significantly for the individual fans in the fan group. Since the fans will be arranged in a common frame, the vibration stress on the fans will be very similar across the fans of the fan group. It is therefore possible to assume identical operating conditions for all fans of the fan group. This in turn enables to utilize one probability distribution for all fans of the fan group.

Therefore, the prediction of the failure of the fan group is carried out according to the disclosure via a probability distribution. In most cases, such probability distributions are parameterized with at least one parameter in which, in the present case, the operating conditions of the fans are expressed. However, assuming identical operating conditions, this at least one parameter is identical for all fans of the fan group. This means that a parameterized probability distribution can easily be used to predict the time of the n-th failure of a fan of the fan group. For this purpose, it is only necessary to determine said at least one parameter. This is achieved by waiting for the first failure of a fan and using it to parameterize the probability distribution.

In the method according to the disclosure, initially a first and an n-th probability of failure are generated, which indicates a probability of a first or an n-th failure of a fan of the fan group. In a further step, a first time of failure is determined, that indicates the operating time of the fan group until the first failure of a fan occurs. The first probability of failure and the first time of failure thereby form a first pair of values characterizing the first failure of a fan of the fan group. This first pair of values is used to generate a parameterized probability distribution by approximating the probability distribution to the first pair of values. In the simplest case, this means that the first pair of values is inserted in the probability distribution and a parameter of the probability distribution is determined and used. If the probability distribution has more than one parameter, it is possible to wait for further failures or reasonable values can be assumed for the other parameters to generate the parameterized probability distribution. Based on the parameterized probability distribution and the n-th probability of failure, the n-th time of failure can then be calculated as the time of the n-th failure of a fan. Since the n-th failure of a fan at the same time means the failure of all redundant fans and thus the failure of the fan group, the n-th time of failure at the same time is the predicted time of failure of the fan group. This time of failure can also be referred to as a “system failure”.

The method according to the disclosure can be used for various fan groups. In most cases, the axes of the fans of the fan group, around which the rotor of the respective fan rotates, are arranged parallel or approximately parallel to one another. Linear arrangements are conceivable as well as two-dimensional arrangements. In the case of a two-dimensional arrangement, the fans of the fan group can be arranged regularly or irregularly. In the case of a regular arrangement, the fans can be offset from one another, for example in a honeycomb-like arrangement. Preferably, the fans of the fan group, however, are arranged in a two-dimensional matrix, so that the fans are arranged in “rows” and “columns”. For example, 3×4 or 4×4 or 5×3 fans can be arranged like a matrix.

The number of fans in the fan group is largely irrelevant. It is essential that n fans of the N fans of the fan group are redundant. This means that a specified minimum delivery rate of the fan group can still be achieved when n−1 fans have failed. In this case, n is greater than 1 and less than or equal to N. Preferably at least 10% of the fans, particularly preferably at least 20% of the fans and very particularly preferably at least 25% of the fans can be considered redundant fans. At the high end also, it is recommended that the number of redundant fans is restricted. Therefore, a maximum of 50% of the fans are preferably redundant fans. For example, if 25% of the fans of the fan group with N=4×4=16 fans are redundant, this fan group has four redundant fans. This means that in the case of failure of three fans, the remaining 13 fans still can manage to take care of the specified minimum delivery rate of the fan group. Not until the fourth redundant fan fails and only 12 fans are operable, the fan group no longer can provide the specified minimum delivery rate meaning that there is a system failure in this example.

In principle, the times of failure could be related to a reference time, for example the time when the fan group was started up for the first time. This means, for example, that the n-th time of failure identifies the operating time between the initial start-up and the time of the n-th failure of a fan. It should be noted, however, that the times can also be relative information. For example, to indicate the predicted time of failure of the fan group it is of secondary importance how many hours or days the fan group has been operating since initial start-up until the system failure occurs. More important it may be how many hours/days of operation remain from the current point in time until the system failure occurs. This means that a time, in particular the predicted time of the system failure, can thus also be a relative indication. Preferably, however, in particular when used in the probability distribution, absolute time specifications are used which particularly preferably relate to an initial start-up of the fan group.

For the method according to the disclosure, it is also in principle irrelevant which technology the motor of the fan has. External rotor motors can be used as well as internal rotor motors. Synchronous motors can be utilized as well as asynchronous motors or other motor technologies. But it may be important that all fans of the fan group are identical in construction in order to be able to obtain comparability of the individual fans.

In a further development, in addition to the first and n-th probabilities of failure, one or more further probabilities of failure are generated. In principle, these further probabilities may relate to the failure of all N fans of the fan group. These further probabilities of failure are designated hereinafter in each case as k-th probability of failure, wherein k is a natural number with 2≤k<N. Preferably, the probabilities of failure are generated relating to the failures between the first and the n-th failure of a fan, that is to say, the future failures after the first failure up to the system failure. In this case the following would apply: 2≤k<n.

In the step of generating a probability of failure, various approaches can be used which provide values for the probabilities of failure of a fan in a fan group. In a first configuration, generating a probability of failure can consist of reading out a probability value stored in a memory. Since the probabilities of failure of the individual fans have been established before starting up the fan group, it is possible to calculate the probabilities of failure in advance and to store them in a memory when configuring the fan group. This memory can then be accessed when the method is carried out. This means that sufficient calculation capacity does not have to be provided at the fan group that would otherwise have to be available for a calculation “on site”. Such a memory is preferably formed as a nonvolatile memory, such as, for example, a flash memory, an EEPROM (Electronically Erasable Programmable Read-Only Memory), an NVRAM (Non-volatile Random Access Memory) or some other semiconductor memory.

In another configuration, the probability of failure (as needed) is determined or approximated in the step of generating a probability of failure. For this purpose, various methods that the statistics provide for such cases can be used. Median rank methods (also known as “median rank”) are preferably used. This method provides a statistical value for the unreliability of each failure. The probability of the k-th failure, for example, is calculated by the following equation:

$$P = {\sum }_{j = k}^{N} ( \begin{matrix}N \\ j\end{matrix} ) {{Z}^{j} ( 1 - Z )}^{N - j}$$

N is the sample size and j is a control variable from the natural numbers. The median rank is then determined by solving the equation P=0.5.

There are several methods that approximate this median rank method or offer an equivalent alternative. As an example, reference is made to the calculations preferably used according to the Kaplan-Meier method, a beta distribution or an F distribution. Particularly preferably, however, a median rank method according to Benard (also referred to as “Benard's median rank”) is used. In this case, the probabilities Pₖ for the k-th failure are calculated using the following formula:

$${P}_{k} = \frac{k - 0.3}{N + 0.4}$$

Here, N is the number of fans of the fan group. This Benard's approximation provides sufficiently precise values for the probabilities of failure and can be used effectively in the method according to the disclosure. Due to its simplicity, this formula is very suitable for a calculation “at operating time” of the procedure.

It should be noted that the aforementioned methods of calculating the probabilities of failure can be used both in the calculation of values stored in a memory and for the calculation of probabilities of failure when the method is carried out.

Since fan failures are subject to probability distributions, it is in principle conceivable that the first fan failure occurs unusually late or unusually early. This would mean that the predicted system failure would not have been established with sufficient reliability. Therefore, in a further development, the probability distribution is updated when the second failure of a fan occurs. For this purpose, in the event of a second failure of a fan, a second time of failure is determined, which indicates the operating time of the fan group until the second failure occurs. If a second probability of failure has not yet been generated, the second probability of failure is also generated indicating a probability of the second failure. Thereafter, the step of generating a parameterized probability distribution is carried out in which the probability distribution is approximated to the first pair of values and a second pair of values consisting of the second probability of failure and the second time of failure. Since the first and the second pair of values usually will not exactly coincide with a probability distribution, a parameterized probability distribution is chosen such that the first and the second pair of values have a minimum distance to the parameterized probability distribution. For this purpose, least squares estimators can be used, for example. In principle, it is conceivable that the step of generating a parameterized probability distribution is carried out after the second failure of a fan and not already after the first failure. On the other hand, this step can also be used to update the preceding parameterization of the probability distribution.

Generally, whenever a failure of ventilator of the fan group occurs, the parameterized probability distribution that has been generated or updated in the previous failure. To this end, when a k-th failure occurs, a k-th time of failure can be determined that indicates the operating time of the fan group until the k-th failure of a fan occurs. In this case, k is a natural number with 2≤k<n. Together with a k-th probability of failure the k-th time of failure forms a k-th pair of values. In updating the parameterized probability distribution the parameter(s) of the probability distribution is/are determined such that all pairs of values consisting of a probability of failure and an associated time of failure for the first up to and including the k-th failure are as close as possible to the updated parameterized probability distribution. Again, a least squares estimator can be used, for example. For example, if k=4, the first, second, third and fourth pair of values would be used in updating the parameterized probability distribution.

The calculated n-th time of failure can change with each update of the parameterized probability distribution. Therefore, preferably, the n-th time of failure and thus the time of a predicted failure of the fan group is recalculated after an adjustment of the parameterized probability distribution. Since—as already mentioned—for a user of the fan group the entire operating time of the fan group until a predicted system failure occurs, is of lesser importance in most cases than the remaining operating time of the fan group, that is to say the remaining service life, the recalculation of the predicted time of a system failure can also be used to recalculate the remaining service life. For this purpose, only the current operating time of the fan group must be deducted from the predicted time of a system failure.

In addition to the calculation of the n-th time of failure further predicted times of failure can be calculated. These further predicted times of failure would relate to all future failures of a fan of the fan group. For the calculation of the further times of failure—as for the calculation of the n-th time of failure—the parameterized probability distribution and a probability of failure of the respective further time of failure would be used.

In principle, a wide variety of probability distributions can be used to calculate the times of failure, which can describe a probability of failure over the operating time of a system. For this purpose, the respective probability distribution must be able to take into account that the sample size is reduced by one with each failure of a fan, i.e. the amount of operable fans is reduced by one with each failure of a fan. In a preferred configuration, the probability distribution of failures, however, is formed by a Weibull distribution, the parameters of which are preferably formed by an offset and/or scaling. The offset here describes how a curve describing the Weibull distribution is shifted within a plot. This offset is usually represented by a shift in the direction of the ordinate. The scaling indicates how strong the Weibull distribution rises.

In one configuration, the probability distribution in a log-log plot is a straight line with a defined slope. The parameter of the probability distribution is formed by a shift of the straight line in the direction of the ordinate. In determining a parameterized probability distribution, the ordinate shift would be determined, in which the probability distribution is as close as possible at the determined pair(s) of value.

The determined n-th time of failure and thus the predicted failure of the fan group can be dealt with in various ways. The determined time may be output to a user, so that said user can get an idea about the remaining operating time of the fan group. This output can take place via a display at the fan group or via a communication link. Such a communication link may be wired or wireless. By way of example, but not limited to these examples, the communication link can comprise an Ethernet network, Modbus, Profibus, Bluetooth, Bluetooth LE (Low Energy) or NFC (Near Field Communication). In this case, the fan group can also be integrated into an Industry 4.0 environment, in which the predicted time of failure is transferred to an evaluation node.

Alternatively or additionally, the predicted time of failure can be output to a system monitoring unit. This system monitoring unit can monitor the fan group with regard to its operating performance. In this way, an alert can be generated upon reaching critical states or an impending system failure. This warning message can, for example, trigger a replacement of the fan group.

According to a further aspect of the disclosure, a system for predicting a failure of a fan group with N fans is provided. This system is formed in particular to carry out a method according to the disclosure. The system includes a monitoring unit, a time measuring unit, a probability unit, a parameterization unit and a failure calculation unit. The monitoring unit is formed for detecting failures of fans in the fan group. This is likely to be achieved in most cases by the fact that the monitoring unit is connected communicatively with the respective motors of the fans or the respective control unit thereof. Once the monitoring unit detects the failure of a fan, said monitoring unit would output a corresponding signaling. The time measuring unit is formed for determining a time of failure of a fan. For this purpose, the time measuring unit is connected communicatively to the monitoring unit and measures the operating time of the fan group. For measuring the operating time, the time measuring unit may be provided with a real-time clock which the time measuring unit can use to determine the operating time of the fan group. As soon as the monitoring unit signals the failure of a fan, the time measuring unit would generate a time of failure which corresponds to the operating time of the fan group until the detected failure occurs. This time of failure would then be transferred to the parameterization unit.

The probability unit is formed to generate probabilities of failure of fans in the fan group. The probability unit transfers the probabilities of failure generated to the parameterization unit which is formed for generating and/or adjusting a parameterized probability distribution. For this purpose, one or more parameter(s) of the probability distribution is/are determined such that the parameterized probability distribution is approximated to at least one generated pair of values, wherein the at least one generated pair of values comprises a probability of failure and an associated measured time of failure. The failure calculation unit is formed for calculating a predicted time of failure of the fan group based on the parameterized probability distribution and an n-th probability of failure.

This system according to the disclosure may be part of a fan group with N fans, wherein n fans of the N fans are redundant.

There are now various possibilities for advantageously configuring and developing further the teaching of the present disclosure. For this purpose, reference is made on the one hand to the claims dependent on claim 1 and on the other hand to the following explanation of a preferred exemplary embodiment of the disclosure with reference to the drawing. In connection with the explanation of the preferred exemplary embodiment of the disclosure with reference to the drawing, generally preferred configurations and further developments of the teaching are also explained. In the drawing

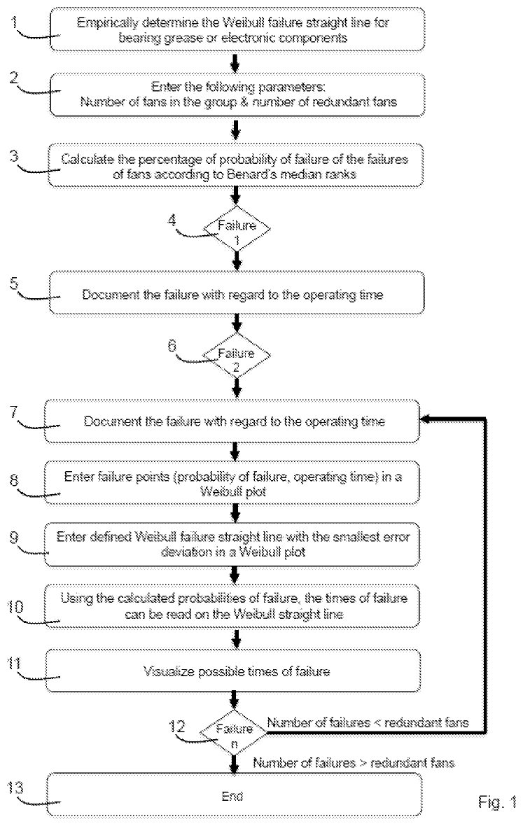

FIG. 1 shows a flow diagram of an exemplary embodiment of a method according to the disclosure,

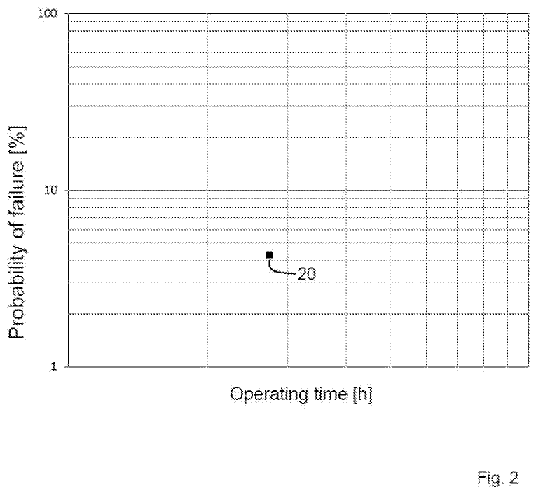

FIG. 2 shows a log-log plot with a first pair of values comprising a probability of failure and an associated time of failure,

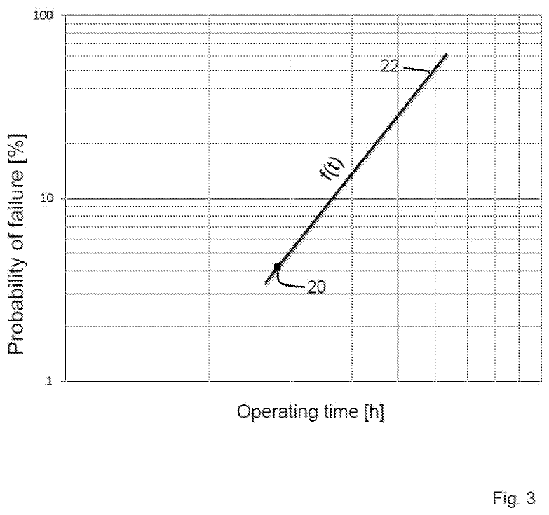

FIG. 3 shows the plot according to FIG. 2, in which a distribution function according to a Weibull distribution is additionally drawn,

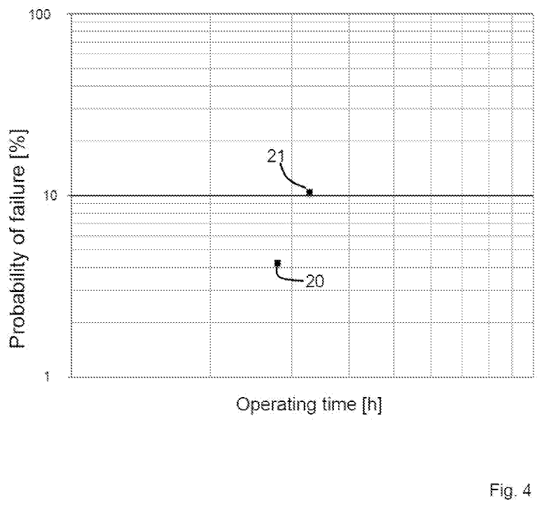

FIG. 4 shows a log-log plot with a first pair of values and a second pair of values, each of which comprises a probability of failure and an associated time of failure,

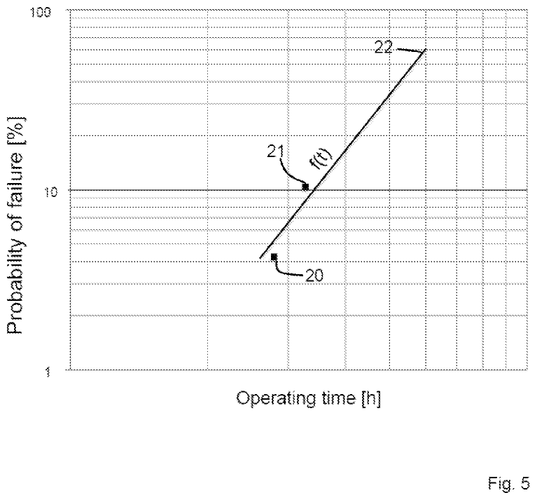

FIG. 5 shows the plot according to FIG. 4, in which a distribution function according to a Weibull distribution is additionally drawn, and

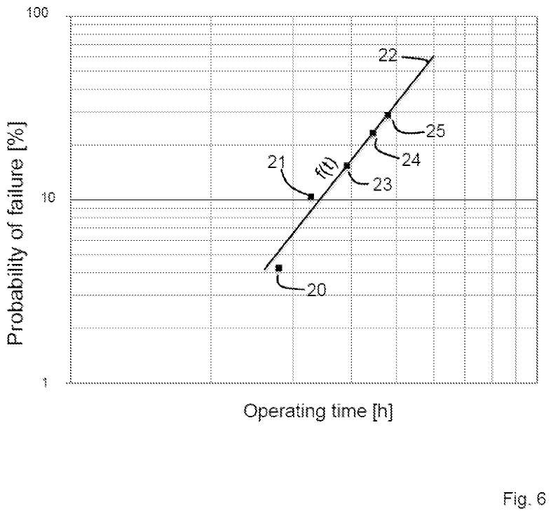

FIG. 6 shows the plot according to FIG. 5, in which a third, a fourth and a fifth pair of values is additionally drawn.

FIG. 1 shows a flow diagram of an exemplary embodiment of a method according to the disclosure which uses a Weibull distribution. In this case, the method is based on the probability distribution for the failure of bearing grease or electronic components. It has been shown that the straight line that describes the Weibull distribution in a log-log plot has a slope that is independent of the operating conditions of the fan. This means that the straight line always has the same slope, regardless of the temperature, the vibration stress or the installation positions the fan is operated at. The Weibull straight line only differs in how it is arranged in the log-log plot. This means that the Weibull straight line, depending on the operating conditions of the fans, has a different ordinate value. This ordinate value represents a parameter of the probability distribution which parameter is to be determined in the method according to the disclosure.

In step 1, the slope of the straight line of the Weibull distribution—the slope of the Weibull straight line—is determined empirically. In this case, the period of use of bearings or the period of use of electronic components is examined in series of measurements. Since the slope does not dependent on specific operating conditions and specific configurations of the fan, the slope will have been determined mostly in advance of carrying out the method according to the disclosure.

In step 2, the parameters of the fan group are entered. These parameters can comprise the number N of the fans of the fan group and the number n of the redundant fans. The parameters are stored in a memory, preferably a non-volatile memory which memory can be accessed by various components of the system according to the disclosure for predicting a failure of the fan group.

In step 3, the probabilities of failure of the fans of the fan group are calculated as percentage values according to Bernard's median rank method. As stated above, the probability of failure can be calculated with the following formula:

$${P}_{k} = \frac{k - 0.3}{N + 0.4}$$

Here, N is the size of the “test population” (i.e., the number of fans) and k is the number of the respective failure. In the following example the assumption is made that the fan group comprises 16 fans, 5 of which are redundant. This results in the following probabilities of failure:

| | |
|---|---|
| k = 1 (first failure): | P₁ = 4.3% |
| k = 2 (second failure): | P₂ = 10.4% |
| k = 3 (third failure): | P₃ = 16.5% |
| k = 4 (fourth failure): | P₄ = 22.6% |
| k = 5 (fifth failure): | P₅ = 28.7% |
| . . . | |
| k = 16 (sixteenth failure): | P₁₆ = 95.7% |

Thus it is known which value of the probability of failure can be assigned to the respective failed fan. The probabilities of failure are used to estimate predicted time of failure for future failure.

In step 4, the first failure of a fan in the fan group occurs. In this case, it is irrelevant which of the fans (16 in the present example) this will be. It is more important that a first fan in the fan group fails. Detecting the failure can be done by a monitoring unit of the system according to the disclosure.

In step 5, this failure is documented with regard to the operating time of the fan group, i.e., a first time of failure is determined which indicates the operating time of the fan group until this first failure occurs. This step can be carried out by a time measuring unit of the system according to the disclosure. The first probability of failure and the first time of failure together form a first pair of values that can be used for generating a parameterized probability distribution.

In principle, by detecting the first failure, a parameterized probability distribution can be determined, which will be explained in more detail with reference to FIGS. 2 and 3. In the present exemplary embodiment of FIG. 1, however, a second failure is awaited, which is detected in step 6. Here, too, it is irrelevant which of the remaining 15 operational fans fails second.

In step 7—as before in step 5—the failure is documented with regard to the operating time of the fan group and a second time of failure is determined. The second time of failure indicates the operating time of the fan group until the second failure of a fan occurs. The second probability of failure and the second time of failure form a second pair of values, which is also used to generate a parameterized probability distribution.

The following determination of a parameterized probability distribution may, for example, be calculated mathematically by a least squares estimator. Such methods are well known from practice. However, the following steps are clearly explained using a graphical solution. For this purpose, in step 8, the first and second pairs of values are first entered in a log-log plot—the so-called Weibull net. The defined Weibull straight line is then, in step 9, entered in the Weibull net with a smallest error deviation. In doing so, the entered Weibull straight line (with the known slope) has a minimum distance to both pairs of values entered. In this way, a parameterized probability distribution has been created, whose slope has been determined empirically and the ordinate section of which has now been established as a parameter of the probability distribution. Using this parameterized probability distribution, in step 10, together with the further probabilities of failure, the estimated future times of failure can be determined. In step 11, the predicted time of failure and thus the predicted failure of the fan group are output. This can be done, for example, by means of a visualization to a user.

In step 12, the next failure of a fan is detected. If not all n redundant fans have failed (number of failures <n), the process continues with step 7 and the next time of failure is determined. In this way, with each looping the parameterization of the parameterized probability distribution and the predicted time of failure of the fan group can be updated. If the number of failures is larger than the number n of the redundant fans, the method is terminated because a system failure has occurred.

With the aid of FIGS. 2 to 6, steps 8 to 11 should be revisited in more detail. Each of the FIGS. 2 to 6 represents a Weibull net, in which the probability of failure is plotted over the operating time of the fan group. Both the abscissa and the ordinate are shown logarithmically. FIGS. 2 and 3 show a method sequence in which a parameterized probability distribution is generated after the first failure. In FIG. 2, the first pair of values is initially drawn, which is defined by the first probability of failure and the first time of failure. In FIG. 3, the Weibull straight line 22 is additionally drawn as a function f(t). Here, the Weibull straight line 22 passes through the point that is represented by the first pair of values. This Weibull straight line represents a first parameterized probability distribution, with which in principle the times of failure to be expected of further fans in the fan group can be determined.

In FIG. 4, in addition to the first pair of values 20, the second pair of values 21 is drawn. In FIG. 5, the Weibull straight line is drawn additionally as a function f(t) of the operating time 22 of the fan group. It can be seen that the Weibull straight line 22 has approximately the same distance from the first pair of values 20 and the second pair of values 21. It can also be seen that the Weibull straight line in FIG. 5 is shifted slightly upwards in comparison to the Weibull straight line in FIG. 3. This means that the first attempt at the parameterized probability distribution would have resulted in slightly too optimistic values for the expected remaining service life and that the change of the parameterization that has taken place now, the estimation of the remaining service lives is improved. Based on the drawn Weibull straight line 22, the further times of failure can be determined. For this purpose, it is considered when the Weibull straight line 22 assumes an associated probability of failure. The third probability of failure—according to Benard's median rank—is at 16.5%, for example. At the point at which the Weibull straight line 22 assumes this value, there is the third pair of values 23, which characterizes a third failure of a fan in the fan group. Thus, the associated third time of failure can be read from the Weibull net. The same procedure can be used for the fourth pair of values 24 and the fifth pair of values 25. These pairs of values are drawn additionally in FIG. 6. Assuming that the fan group has n=5 redundant fans, it means that with the fifth time of failure the last redundant, operational fan had failed, so that at this time the fan group has failed also, that is to say a system failure has occurred.

With regard to further advantageous configurations of the teaching according to the disclosure, reference is made to the general part of the description and to the appended claims in order to avoid repetition.

Finally, it should be explicitly noted that the above-described exemplary embodiment is merely for explaining the claimed teaching, but do not limit said teaching to the exemplary embodiments.

### LIST OF REFERENCE NUMERALS

20 First pair of values
21 Second pair of values
22 Weibull straight line
23 Third pair of values
24 Fourth pair of values
25 Fifth pair of values

1. A method for predicting a failure of a fan group with N fans, of which n fans are redundant, wherein upon failure of n fans, there is a failure of the fan group, wherein 1<n≤N, wherein probabilities of failure of the fans as a function of an operating time of the fan group can be described by a probability distribution, and the probability distribution can be parameterized by at least one parameter, comprising the steps of:
generating a first probability of failure, which indicates a probability of a first failure of a fan of the fan group,
generating an n-th probability of failure, which indicates a probability of an n-th failure of a fan of the fan group,
determining a first time of failure, wherein the first time of failure indicates an operating time of the fan group until the first failure of a fan occurs,
generating a parameterized probability distribution by approximating a probability distribution using a first pair of values including the first probability of failure and the first time of failure, and
calculating the n-th time of failure, which indicates a time of the n-th failure of a fan using the parameterized probability distribution and the n-th probability of failure.

2. The method according to claim 1, further comprising the step of generating a k-th probability of failure, wherein the k-th probability of failure indicates a probability of a k-th failure of a fan of the fan group, wherein 2≤k<n.

3. The method according to claim 1, wherein the step of generating the first or a subsequent probability of failure comprises the step of reading a probability value stored in a memory.

4. The method according to claim 1, wherein the step of generating the first or a subsequent probability of failure comprises the step of determining or approximating a probability value.

5. The method according to claim 4, wherein the step of determining or approximating a probability value comprises the step of using at least one of a median rank method according to Benard, a Kaplan-Meier method, a beta distribution, and an F-distribution.

6. The method according to claim 1, further comprising the step of determining a second time of failure, wherein the second time of failure indicates an operating time of the fan group until a second failure of a fan occurs, and the step of generating the parameterized probability distribution includes approximating the probability distribution using the first pair of values and a second pair of values including a second probability of failure and the second time of failure.

7. The method according to claim 1, further comprising the step of determining a k-th time of failure is determined, wherein 2≤k<n and the k-th time of failure indicates an operating time of the fan group up to the k-th failure of a fan, and the step of generating the parametrized probability distribution is adjusted such that the probability distribution is approximated using k pairs of values, the pairs of values including a probability of failure and an associated time of failure for each failure of a fan up to and including the k-th time of failure.

8. The method according to claim 7, wherein after adjusting the parameterized probability distribution, the n-th time of failure is recalculated.

9. The method according to claim 1, further comprising the step of calculating times of future failures of a fan of the fan group using the parameterized probability distribution and, for each future failure, an associated failure probability.

10. The method according to claim 1, wherein the probability distribution comprises a Weibull distribution.

11. The method according to claim 1, wherein the probability distribution is represented by a straight line having a defined slope in a log-log plot or in a Weibull plot, and a value of a parameter of the probability distribution is determined by shifting the straight line.

12. The method according to claim 1, further comprising the step of outputting the n-th time of failure to at least one of a user and a system monitoring unit.

13. The method according to claim 1, wherein n is at least about 10% of N.

14. A system for predicting a failure of a fan group with N fans, of which n fans are redundant, wherein 1<n≤N and upon failure of n fans there is failure of the fan group, and probabilities of failure of the fans as a function of operating time of the fan group can be described by a probability distribution, comprising:
a monitoring unit configured for detecting failures of fans of the fan group,
a time measuring unit configured for determining a time of failure of a fan, wherein the time measuring unit communicates with the monitoring unit and measures the operating time of the fan group until a failure of a fan occurs,
a probability unit configured for generating probabilities of failure of fans of the fan group,
a parameterization unit configured for generating and/or adjusting a parameterized probability distribution by approximating the probability distribution using at least one generated pair of values, wherein the at least one generated pair of values comprises a probability of failure and an associated measured time of failure, and
a failure calculation unit configured for calculating a predicted time of failure of the fan group based on the parameterized probability distribution and an n-th probability of failure.

15. A fan group comprising N fans, of which n fans are redundant, and a system according to claim 14 for predicting a failure of the fan group.
